(19) United States
(12) Patent Application Publication
(10) Pub. No.: US 2025/0293624 A1
(43) Pub. Date: Sep. 18, 2025

(54) METHOD FOR DETERMINING AN INITIAL ROTOR POSITION OF A ROTOR, COMPUTER PROGRAM PRODUCT, CONTROL UNIT, ELECTRIC MACHINE, INSPECTION AND/OR TEST METHOD AND TEST STAND

(71) Applicant: Schaeffler Technologies AG & Co. KG, Herzogenaurach (DE)

(72) Inventors: Erhard Hodrus, Achern (DE); Christian Eberle, Bühl (DE)

(73) Assignee: Schaeffler Technologies AG & Co. KG, Herzogenaurach (DE)

(21) Appl. No.: 18/860,001

(22) PCT Filed: Mar. 29, 2023
(86) PCT No.: PCT/DE2023/100243

§ 371 Date: Oct. 25, 2024

(30) Foreign Application Priority Data
Apr. 28, 2022 (DE) 10 2022 110 304.8

(51) Int. Cl. H02P 21/18; G01M 99/00

(52) U.S. Cl. CPC H02P 21/18; G01M 99/005; H02P 2207/05

(57) ABSTRACT

A method for determining an initial rotor position of a rotor of an electric machine, in particular a synchronous electric machine.

### CROSS-REFERENCE TO RELATED APPLICATIONS

This application is the U.S. National Phase of PCT Appln. No. PCT/DE2023/100243 filed Mar. 29, 2023, which claims priority to DE 10 2022 110 304.8 filed Apr. 28, 2022, the entire disclosures of which are incorporated by reference herein.

### TECHNICAL FIELD

The present disclosure relates to a method for determining an initial rotor position of a rotor of an electric machine, in particular a synchronous electric machine. The disclosure further relates to a computer program product, a control unit, an electric machine, an inspection and/or test method for checking an electric machine in a test stand and a test stand for carrying out an inspection and/or test method for checking an electric machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort to which they are accustomed.

In electric motors, it is also very important how the parts through which the magnetic field flows are positioned relative to each other. This applies both to the mechanical structure of the electric motor, through which the parts are held and positioned precisely, and to the precise knowledge of the angular position of the rotating parts, because the constantly changing position of the magnets integrated in the rotating rotor (angular position) as the motor rotates must always be known exactly relative to the magnet integrated in the stator in order to be able to control the electric motor correctly. The changing angular position of the rotor must be known precisely at all times to determine the orientation of the rotor components (e.g., the rotor magnets, which are usually designed as permanent magnets) relative to the stator components (e.g., the stator magnets, which are usually designed as electromagnets) and to be able to adjust the control of the motor accordingly.

The control of such an electric motor is therefore achieved by applying a rotating field to the windings of the motor. Depending on the rotor position angle, the rotating field must be adjusted via a control system. As a rule, the position of the rotor is measured using a rotor position sensor and the determined rotor position angle is transferred to the electric motor control.

In order to save costs and installation space, however, sensorless controls have already become known which do not require a physical rotor position sensor. Only the current sensors, which are indispensable for field-oriented control anyway, are used here. This control concept, which is particularly widespread in 3-phase permanent magnet synchronous machines, is based on a transformation of the 3-phase alternating variables into a two-axis coordinate system which rotates synchronously with the rotor flux of the machine. In such a coordinate system, commonly referred to as a d/q coordinate system, for example, the three phase currents of the stator winding i_u, i_v, i_w are represented by a 2-dimensional current vector with the components i_q and i_d. For an ideal sinusoidal rotor flux and ideal sinusoidal phase currents, the original alternating quantities i_u, i_v, i_w are mapped to equal quantities i_q, i_d as a result of the rotor flux-synchronously rotating coordinate system.

In field-oriented current regulation, the voltage values or current values of the phases of the stator of the synchronous machine are transformed in a known manner to a two-dimensional coordinate system, the mutually perpendicular axes of which are usually referred to as d (“direct”) and q (“quadrature”). This coordinate system rotates relative to the stator of the synchronous machine and rests relative to the rotor of the synchronous machine. The transformation itself is called the Park transformation; the two-dimensional coordinate system to which it is transformed is called the Park coordinate system. The Park transformation can occur via the intermediate step of an, also known, Clarke transformation, which transforms the voltage values or current values of the phases of the stator of the synchronous machine to a two-dimensional, orthogonal coordinate system that is stationary relative to the stator.

When an electric motor is operated without sensors, as already mentioned above, the rotor position sensor, which is usually used to determine the current angle of the rotor, is omitted. For example, current sensor signals and measured or estimated phase voltages are used to determine the rotor position and speed of the motor via a model. Below a speed threshold of the absolute speed, it is necessary to feed in what are termed injection signals, which support the identification of the rotor position and the speed in this speed range. Starting with a stationary rotor, the rotor position must be determined by an initialization routine.

The initial rotor position can be determined by specifying an alternating voltage excitation, a high-frequency oscillation in d- and q-voltage, for a certain number of points on a voltage circuit path, in which the exciting voltage amplitude leads to a resulting current amplitude. Due to the d-q coordinates, an ellipse in the d-q plane must be formed in the case of a circular excitation in the voltage in the current. The main axis of the ellipse corresponds to the d-direction. This direction of the main axis describes the initial value of the rotor position.

One way to determine the initial rotor position is to move to several points on the circular path, which results in several points on an ellipse. From these points the angular position of the semi-axes of the ellipse must then be determined. If one chooses many points, the result is more accurate, but it takes a certain amount of time since each point must be approached and evaluated stably with a different amplitude in the d and q directions. If you choose fewer points, the process will be faster, but the result may then be inaccurate because the angular position of the semi-axes cannot be determined as well from the few points. The measurement data during evaluation are subject to a certain amount of noise, which ultimately distorts the result.

### SUMMARY

The object of the disclosure is therefore to provide an improved—in particular faster and more accurate-method for determining an initial rotor position of a rotor of an electric machine, in particular a synchronous electric machine. It is furthermore the object of the disclosure to realize a computer program product for carrying out an improved method for determining an initial rotor position of a rotor of an electric machine, in particular a synchronous electric machine. It is also the object of the disclosure to develop a control unit for carrying out an improved method for determining an initial rotor position of a rotor of an electric machine, in particular a synchronous electric machine. A final object of the disclosure is also to provide an improved electric machine. The object of the disclosure is also to realize an improved inspection and/or test method for checking an electric machine in a test stand and an optimized test stand for carrying out an inspection and/or test method for checking an electric machine.

This object is achieved by a method for determining an initial rotor position of a rotor of an electric machine, in particular a synchronous electric machine, comprising the following steps:
a) Provision of an electric machine with a stationary rotor,
b) Provision of a starting value d_est, which represents a first angle of the rotor position,
c) Generation of a three-phase alternating voltage excitation in the electric machine by specifying an alternating voltage in a d_est direction,
d) Conversion of the three-phase current response to the alternating voltage excitation of the electric machine for a first modified value d_est−45° into a first alternating current component i_[d_est−45°],
e) Conversion of the three-phase current response to the alternating voltage excitation of the electric machine for a second modified value d_est+45° into a second alternating current component i_[d_est+45°],
f) Calculation of the length of a first alternating current vector having d and q components for the first alternating current component i_[d_est−45°],
g) Calculation of the length of a second alternating current vector having d and q components for the second alternating current component i_[d_est+45°],
h) Determination of the difference in the magnitudes of the lengths between the first alternating current vector and the second alternating current vector according to delta i=|i_d_est+45°|−|i_d_est−45°|,
i) If the condition is met that the difference in the magnitudes of the lengths between the first alternating current vector and the second alternating current vector is within a defined interval between and a defined error tolerance value FTW, according to delta_i=li_d_est+45°|−|i_d_est−45°|=[0-FTW], provision of the initial rotor angle for energizing the electric machine and terminating the method,
j) If the condition is met that the difference in the magnitudes of the lengths between the first alternating current vector and the second alternating current vector delta i=|i_d_est+45°|−|i_d_est−45°|>0,
k) In the case that |i_d_est+45°|>|i_d_est−45°|, adjusting the starting value d_est in such a way that the angle representing the rotor position is rotated clockwise by a predetermined amount and
1) In the case that |i_d_est+45°|<|i_d_est−45°|, adjusting the starting value d_est in such a way that the angle representing the rotor position is rotated counterclockwise by a predetermined amount,
m) Repetition of steps c)-1).

This has the advantage that the initial rotor position can be determined particularly quickly and reliably using an iterative procedure without a physical rotor position sensor. Furthermore, the method according to the disclosure can also prevent the electric machine from rotating in the wrong direction, even for a short time, during motor operation.

At the beginning of the iterative solution algorithm, the first iteration is carried out with a randomly chosen starting value for the angle. The three-phase current response to an alternating voltage excitation of the system in the supposed d-direction is then converted into d-q-currents using the known methods. However, this conversion is not carried out with the assumed angle d_est as such, but with the modified angle d_est−45°, which corresponds to the assumed angle d_est minus 45°. This results in an alternating current component) i_(d_est−45° in this direction. The corresponding currents in the d-q plane are also calculated for the assumed angle plus 45°, resulting in the alternating current component) i_(d_est+45°. At the end of the iteration, the direction of the supposedly “correct” d-axis is adjusted using the difference in the length of the alternating current vector, which has d- and q-components. After a few iterations, both vectors) i_(d_est−45° and) i_(d_est+45° are approximately the same length. The d-axis has then been determined and from this direction the initial rotor angle can be read. This is explained in more detail below with reference to the figures in the descriptions of the embodiments. The individual elements of the claimed subject matter of the disclosure are explained, after which preferred embodiments of the subject matter of the disclosure are described.

For the purposes of this application, motor vehicles are land vehicles that are moved by machine power without being bound to railroad tracks. A motor vehicle can be selected, for example, from the group of passenger cars (PKW), trucks (LKW), small motorcycles, light motor vehicles, motorcycles, motor buses/coaches (KOM) or tractors. A hybrid electric vehicle (HEV) is an electric vehicle that is driven by at least one electric motor and another energy converter and draws energy from its electrical storage unit (battery) as well as from an additional fuel that it carries.

In the context of this application, the drive train of a motor vehicle is understood to mean all components that generate the power for driving the motor vehicle in the motor vehicle and transmit it to the road via the vehicle wheels.

An electric machine is used to convert electrical energy into mechanical energy and/or vice versa. In the context of the disclosure, the electric machine of an axle drive train can be configured as a radial or axial flux machine. To form an axially particularly compact axle drive train, preference should be given to axial flux machines.

An electric machine serves generally comprises a stationary part referred to as a stator or armature, and a part referred to as a rotor arranged to be movable relative to the stationary part. An electric machine can be designed to run dry or wet.

The electric machine is intended in particular for use within an electrically operable drive train of a motor vehicle. In particular, the electric machine is dimensioned such that vehicle speeds of more than 50 km/h, preferably more than 80 km/h, and in particular more than 100 km/h can be achieved. The electric motor particularly preferably has an output of more than 30 kW, preferably more than 50 KW, and in particular more than 70 kW. Furthermore, it is preferred that the electric machine provides speeds greater than 5000 rpm, particularly preferably greater than 10,000 rpm, very particularly preferably greater than 12,500 rpm.

The rotor position sensor is preferably designed as an absolute or relative rotor position sensor for an electric machine. The rotor position sensor preferably provides a sensor signal representing the rotor position. Most preferably, the sensor signal is sent to a control unit for controlling the electric machine.

An electric machine can furthermore have a control unit. A control unit, as used in the present disclosure, serves in particular in open- and/or closed-loop electronic control of one or more technical systems of an electric machine.

A control unit has, in particular, a wired or wireless signal input for receiving, in particular, electrical signals, such as sensor signals, for example. Furthermore, a control unit also preferably has a wired or wireless signal output for the transmission of, in particular, electrical signals.

Open-loop control operations and/or closed-loop control operations can be carried out within the control unit. It is very particularly preferable that the control unit comprises hardware that is designed to run software. The control unit preferably comprises at least two electronic processors for executing program sequences defined in software. The two processors can also be structurally integrated into a processor as computer cores, whereby the corresponding computer cores then each represent a processor within the meaning of the disclosure.

The control unit can also have one or more electronic memories in which the data contained in the signals transmitted to the control unit can be stored and read out again. Furthermore, the control unit can have one or more electronic memories in which data can be stored in a modifiable and/or non-modifiable manner.

A control unit can comprise a plurality of control devices which are arranged in particular spatially separate from one another in the motor vehicle. Controllers are also referred to as electronic control units (ECU) or electronic control modules (ECM) and preferably have electronic microcontrollers for carrying out computing operations for processing data, particularly preferably using software. The controllers can preferably be interconnected with one another such that a wired and/or wireless data exchange between controllers is made possible. In particular, it is also possible to interconnect the controllers with one another via bus systems present in the motor vehicle, such as a CAN bus or LIN bus for example.

Very particularly preferably, the control unit has at least one processor and at least one memory, which in particular contains a computer program code, wherein the memory and the computer program code are configured to cause the control unit to execute the computer program code with the processor.

The control unit can particularly preferably comprise a power electronics unit for energizing the stator or rotor. A power electronics unit is preferably a combination of different components that provide an open- or closed-loop control of a current to the electric machine, preferably including the peripheral components required for this purpose, such as cooling elements or power supply units. In particular, the power electronics unit contains one or more power electronics components that are designed to provide an open- or closed-loop control of a current. These are particularly preferably one or more power switches, such as power transistors. The power electronics unit particularly preferably has more than two, particularly preferably three, phases or current paths which are separate from one another and each have at least one separate power electronics component. The power electronics unit is preferably designed to provide an open- or closed-loop control of a power per phase with a peak power, preferably continuous power, of at least 10 W, preferably at least 100 W, particularly preferably at least 1000 W.

Advantageous embodiments of the disclosure are specified in the claims. The features listed individually in the claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the starting value d_est is chosen randomly when the procedure is run for the first time.

The object of the disclosure can also be achieved by a computer program product stored on a machine-readable medium, or a computer data signal made manifest by an electromagnetic wave, with program code suitable for carrying out the method according to the disclosure.

Furthermore, the object of the disclosure can also be achieved by a control unit for controlling and energizing an electric machine in particular a synchronous electric machine, comprising a processor and a memory containing a computer program code, wherein the memory and the computer program code are configured with the processor to cause the control unit to carry out a method according to the disclosure. According to another particularly preferred embodiment of the disclosure, it can be provided that the control unit does not have a connection for a rotor position sensor for detecting the rotor position of the rotor, so that the control unit or the electric machine controlled by it does not require a physical rotor position sensor.

Finally, the object of the disclosure can also be achieved by an electric machine, in particular a synchronous electric machine, comprising a stator and a rotor rotatable relative to the stator and a control unit for controlling and energizing the electric machine, characterized in that the control unit is a control unit according to embodiments disclosed herein. In a likewise preferred embodiment of the disclosure, it can also be provided that the electric machine does not have a rotor position sensor for detecting the rotor position of the rotor. It may also be advantageous to further develop the disclosure such that the electric machine is configured for use in an electrically operable or hybrid drive train of a motor vehicle.

Furthermore, it may be particularly preferred to use the method according to the disclosure during a test and/or inspection cycle of the electric machine during its manufacture. During production, an electric machine will usually be operated for various tests and inspections, for example to run an acceptance profile for quality and functional control before delivery of the electric machine. In this state, the electric machine usually does not have its own rotor position sensor, since this rotor position sensor is usually only added during assembly in the vehicle. During acceptance, each electric motor to be tested is combined with a rotor position sensor permanently mounted on a corresponding test stand for the corresponding test. With this rotor position sensor, which is not optimally adapted to this electric motor, the electric machine is currently operated in the test stand in order to then complete a test and/or inspection cycle. Due to time constraints, the offset angle of the rotor position signal is usually not programmed. The electric machine cannot therefore be operated optimally during these test and/or inspection cycles because the rotor position angle offset cannot be adjusted during production. Thus, the electric machine may exhibit a significant rotor position angle error in a test and/or inspection cycle.

The method according to the disclosure for determining an initial rotor position of the rotor of an electric machine therefore proposes—as already explained above—to find the longer main axis of the ellipse, which corresponds to the d-axis, by means of an iterative control approach. By applying the injection signal on the voltage, a current can be measured. However, this is not transformed into the notional d-direction, but into the notional d−45° direction and notional d+45° direction. This allows significantly larger amplitudes in the current to be achieved compared to an evaluation of the currents in d- and q-direction, where the current in q-direction disappears when the real d-axis is found. This makes detection more robust against disturbances, especially in dynamic situations. The amplitude of the injection signal is then determined using bandpass filtering and the two values for +45° are compared. The assumed angle is then corrected so that the two amplitudes in the direction +45° and −45° become equal. The correction is chosen in such a way that the longer semi-axis is found, i.e., the d-axis. If the sign is reversed during the correction, the algorithm finds the shorter semi-axis, i.e., the q-axis. This approach cannot only be used to find the initial angle, but also to operate the electric machine with it, in particular, during a test cycle in the production of the electric machine.

The production of the electric machine also includes, in particular, the state of the electric machine when it is not installed in a motor vehicle. In particular, this also includes operation of the electric machine for inspection and test purposes outside of a motor vehicle. This operation for inspection and test purposes can preferably be carried out on a test stand for the electric machine.

The object of the disclosure can thus also be achieved by an inspection and/or test method for checking an electric machine according to the disclosure in a test stand, wherein, for operating the electric machine in the test stand, the initial rotor position of the rotor of the electric machine is determined by a method according to the disclosure.

The object of the disclosure can further be achieved by an inspection and/or test method for checking an electric machine in a test stand, wherein the test stand for operating the electric machine comprises a control unit according to the disclosure for controlling and energizing the electric machine and the initial rotor position of the rotor of the electric machine is determined by a method according to the disclosure.

In contrast to back-EMF based methods, the proposed methods do not require any motor parameters, only the filters of the method must be set within a suitable range. Inaccuracies from engine parameters therefore play no role.

Due to the sensorless operation, the test objects can be operated at the optimal angle. This makes the measurement results better and more comparable. The torque and speed that the engine can actually generate can be evaluated. In the variant with a non-programmed rotor position sensor, the achievable torque and the achieved speed are only partially meaningful.

The angle learned through sensorless operation can be related to the fixed angle. This allows the sensorless angle to be validated, since it should always remain within a certain range of the measured fixed angle after a defined settling process, in the sense of a plausibility check.

The object of the disclosure can also be achieved by a test stand for carrying out an inspection and/or test method for checking an electric machine, comprising a holder for the electric machine and a control unit according to the disclosure for controlling and energizing the electric machine.

The electric machine can therefore be operated and controlled during production without a rotor position sensor. The sensorless operation with the method according to the disclosure for determining the initial rotor position of the rotor of the electric machine can accurately determine the correct motor angle in the shortest possible time and thus enables optimal operation for each motor in the corresponding test and/or inspection cycle.

The disclosure is explained in more detail below with reference to figures without limiting the general concept of the disclosure.

### BRIEF DESCRIPTION OF THE DRAWINGS

In the drawings:

FIG. 1 shows different positions of the d-axis in a d/q coordinate system,

FIG. 2 shows an electric machine in a schematic sectional view,

FIG. 3 shows motor vehicles with one hybrid and one fully electric drive train in a schematic representation,

FIG. 4 shows a first embodiment of a test stand in a schematic block circuit view,

FIG. 5 shows a second embodiment of a test stand in a schematic block circuit view,

### DETAILED DESCRIPTION

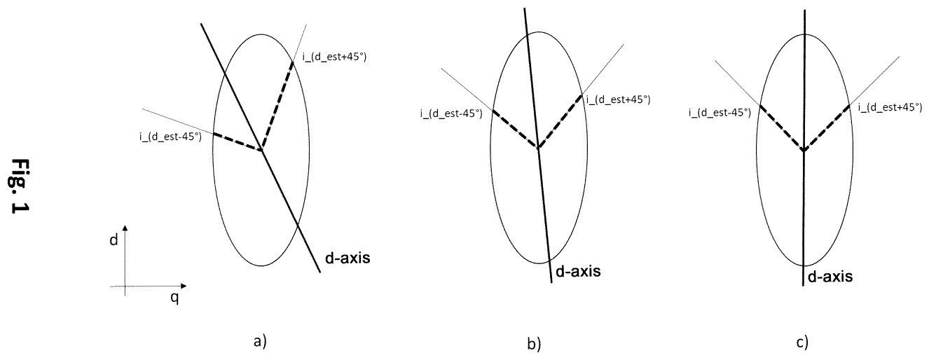

The method for determining an initial rotor position of a rotor 1 of an electric machine 2, in particular a synchronous electric machine, is explained in more detail below with reference to FIG. 1.

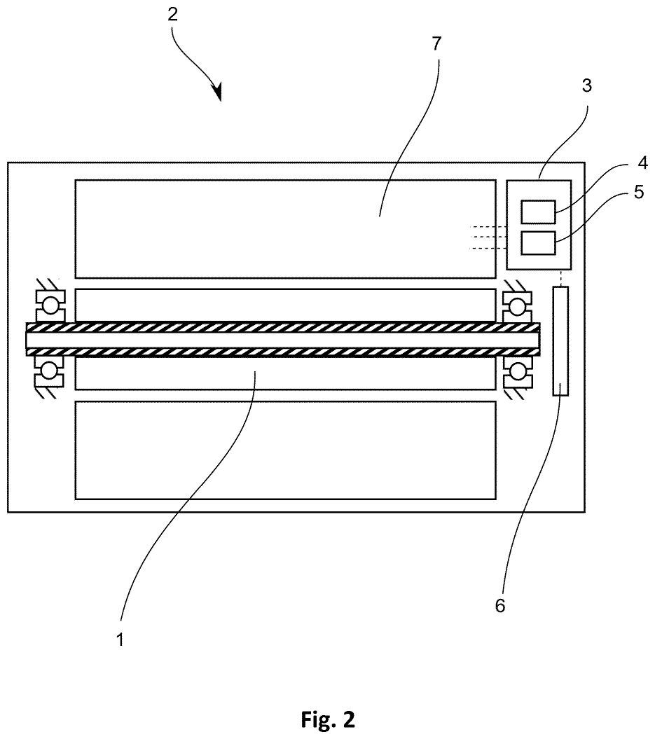

First, an electric machine 2 with a stationary rotor 1 is provided, as shown by way of example in FIG. 2. By means of the control unit 3, in the electric machine 2 a three-phase alternating voltage excitation is then generated in the electric machine 2, which is also indicated in FIG. 2 with the three parallel dashed lines between the control unit 3 and the energized stator 7.

First, a random starting value d_est is provided, which represents a first angle of the rotor position. Based on this starting value d_est, the alternating voltage excitation is applied in d_est direction. The three-phase current is measured and transformed into the d_est−45° direction, and the modified value d_est−45° is calculated. Analogously, a second modified value d_est+45° is calculated, which corresponds to the starting value d_est plus 45°.

Subsequently, a conversion occurs of the three-phase current response to the alternating voltage excitation of the electric machine 2 for the first modified value d_est−45° into a first alternating current component i_[d_est−45°], and the conversion occurs of the three-phase current response to the alternating voltage excitation of the electric machine for the second modified value d_est+45° into a second alternating current component i_[d_est+45°].

These two alternating current components are shown in Images a)-c) of FIG. 1. Now the calculation of the length of a first alternating current vector having d- and q-components for the first alternating current component i_[d_est−45°] is carried out, as well as the calculation of the length of a second alternating current vector having d- and q-components for the second alternating current component i_[d_est+45°].

FIG. 1 schematically shows corresponding ellipses in the real d-q plane. The “estimated” d-axis (d_est) is shown and does not coincide with the direction of the d-axis of the d-q plane. The alternating current components) i_(d_est+45° and) i_(d_est−45° are plotted to match the estimated direction of the d-axis.

Then the difference in the magnitudes of the lengths between the first alternating current vector and the second alternating current vector is determined according to delta i=|i_d_est+45°|−|i_d) est−45°.

If the condition is met that the difference in the magnitudes of the lengths between the first alternating current vector and the second alternating current vector delta i=|i_d_est+45°|−|i_d_est−45°|>0, which can be seen in Images a) and b) of FIG. 1, a distinction is made between two further alternatives.

For the first case in which |i_d_est+45°|>|i_d_est−45°|, the starting value d_est is adjusted in such a way that the angle representing the rotor position is rotated clockwise by a predetermined amount, which is shown in Images a) and b).

From Images a) and b) in FIG. 1 it is clearly visible that the lengths of the alternating current components are different. Therefore, the “estimated” d-axis (d_est) must be rotated clockwise a short way. This new “estimated” d-direction is then the new starting value for the next iteration. One of the next iterations is shown in Image b) of FIG. 1.

For the second case in which |i_d_est+45°|<|i_d_est−45°|, an adjustment of the starting value d_est is made in such a way that the angle representing the rotor position is rotated counterclockwise by a predetermined amount, which is not shown in FIG. 1.

These iterations are carried out until the condition is met that the difference in the magnitudes of the lengths between the first alternating current vector and the second alternating current vector is within a defined interval between 0 and a defined error tolerance value FTW, according to delta i=|i_d_est+45°|−|i_d_est−45°|=[0-FTW].

In other words, the process is repeated until the projections of the alternating current components and thus the lengths of the absolute values of the alternating current components are equal. The initial angle of the rotor position can then be easily determined from the angle of the “estimated” d-axis. This can be seen in Image c) of FIG. 1. Then, on this basis, the initial rotor angle is provided to energize the electric machine and terminate the process.

After this initial angle determination, the d-axis is known and the electric machine 2 can be rotated in the desired direction. This can prevent the electric machine from rotating in the wrong direction, even for a short time, during motor operation. A possible “180° error” must—as with the method known from the state of the art-still be identified and eliminated using a suitable standard procedure.

As shown in FIG. 2, the control unit 3 for controlling and energizing the electric machine 2 comprises a processor 4 and a memory 5 containing a computer program code, wherein the memory 5 and the computer program code are configured, with the processor 4, to cause the control unit 3 to carry out the above method.

Unlike what is shown in FIG. 2, the control unit 3 preferably does not have a connection for a rotor position sensor 6 for detecting the rotor position of the rotor 1, and can be controlled without a sensor. The electric machine 2 shown in FIG. 2 has a stator 7 that can be energized and a rotor 1 that can be rotated relative to the stator 7, as well as the control unit 3 for controlling and energizing the electric machine 2 or the stator 7.

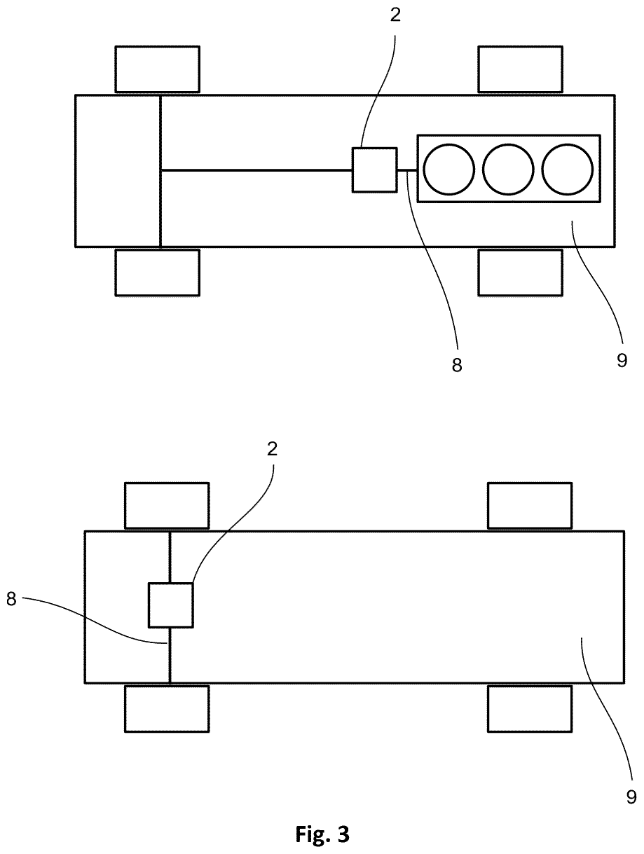

In particular, the electric machine 2 is intended for use in a hybrid or fully electric drive train 8 of a motor vehicle 9, as outlined in FIG. 3.

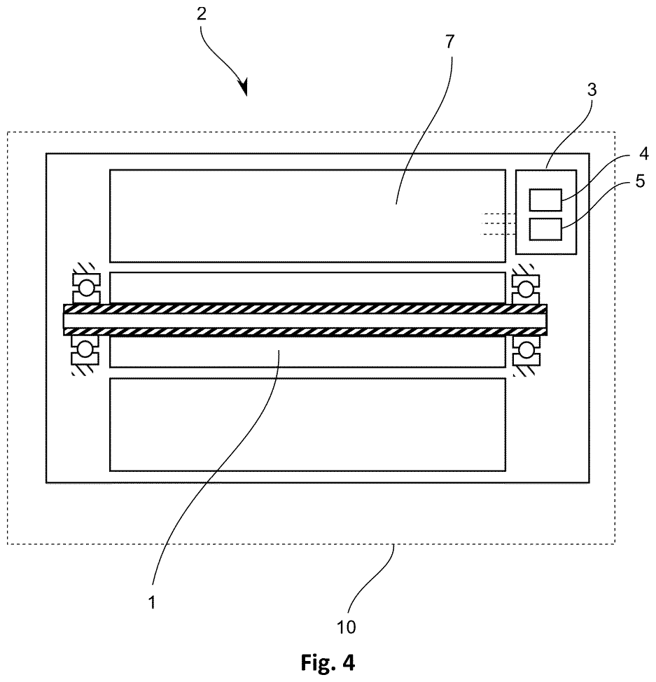

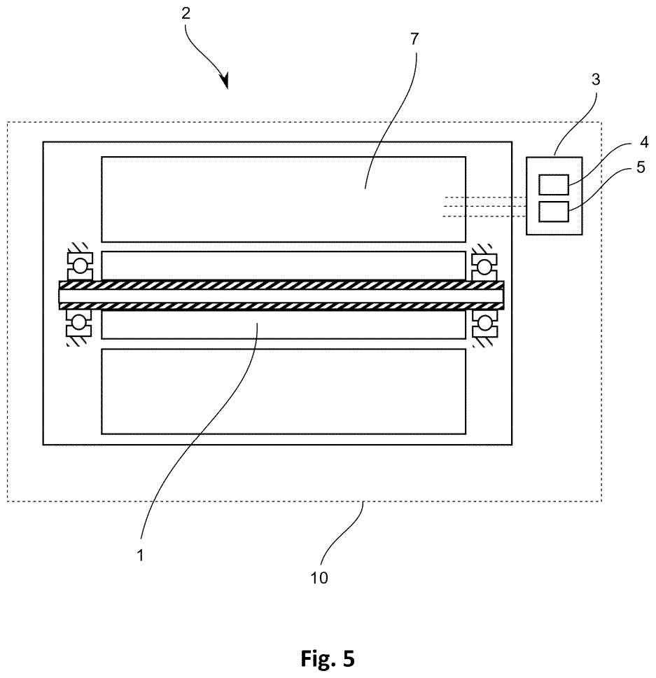

The described method can also be used within an inspection and/or test method for checking an electric machine 2, as known from FIG. 2, on a test stand 10. In order to operate the electric machine 2 in the test stand 10, the initial rotor position of the rotor 1 of the electric machine 2 is determined by the described method for determining the initial rotor position of the rotor 1 of the electric machine 2. This structure of the test stand 10 is shown in FIG. 4. The electric machine 2 is thus already tested with its control unit 3 and is energized via the control unit 3. However, it would also be conceivable for the test stand 10 to have a control unit 3 via which the electric machine 2 is energized, as outlined in FIG. 5.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Rotor

2 Electric machine

3 Control unit

4 Processor

5 Memory

6 Rotor position sensor

7 Stator

8 Drive train

9 Motor vehicle

10 Test stand

1. A method for determining an initial rotor position of a rotor of an electric machine, comprising the following steps:
a) providing an electric machine with a stationary rotor,
b) providing a starting value d_est, which represents a first angle of the rotor position,
c) generating a three-phase alternating voltage excitation in the electric machine by specifying an alternating voltage in a d_est direction,
d) converting the three-phase current response to the alternating voltage excitation of the electric machine for the first modified value d_est−45° into a first alternating current component i_[d_est−45°],
e) converting the three-phase current response to the alternating voltage excitation of the electric machine for the second modified value d_est+45° into a second alternating current component i_[d_est+45°],
f) calculating the length of a first alternating current vector having d and q components for the first alternating current component i_[d_est−45°],
g) calculating the length of a second alternating current vector having d and q components for the second alternating current component i_[d_est+45°],
h) determining the difference in the magnitudes of the lengths between the first alternating current vector and the second alternating current vector according to delta i=|i_d_est+45°|−|i_d_est−45°|,
i) If wherein if the condition is met that the difference in the magnitudes of the lengths between the first alternating current vector and the second alternating current vector is within a defined interval between and a defined error tolerance value FTW, according to delta i=|i_d_est+45°|−|i_d_est−45°|=[0−FTW], providing the initial rotor angle for energizing the electric machine and terminating the method,
j) wherein if the condition is met that the difference in the magnitudes of the lengths between the first alternating current vector and the second alternating current vector delta i=|i_d_est+45°|−|i_d_est−45°|>0,
k) wherein in the case that |i_d_est+45°|>|i_d_est−45°|, adjusting the starting value d_est in such a way that the angle representing the rotor position is rotated clockwise by a predetermined amount and
l) wherein in the case that |i_d_est+45°|<|i_d_est−45°|, adjusting the starting value d_est in such a way that the angle representing the rotor position is rotated counterclockwise by a predetermined amount, and
m) repeating steps c).

2. The method according to claim 1, wherein:
the starting value d_est is chosen randomly when the procedure is run for the first time.

3. A computer program product stored on a machine-readable medium, or a computer data signal made manifest by an electromagnetic wave, with program code suitable for carrying out the method according to claim 1.

4. A control unit for controlling and energizing an electric machine, comprising a processor and a memory containing a computer program code, wherein the memory and the computer program code are configured, with the processor, to cause the control unit to carry out a method according to claim 1.

5. The control unit according to claim 4, wherein:
the control unit does not have a connection for a rotor position sensor for detecting the rotor position of the rotor.

6. An electric machine, comprising a stator and a rotor rotatable relative to the stator and a control unit for controlling and energizing the electric machine, wherein the control unit is a control unit according to claim 4.

7. The electric machine according to claim 6, wherein:
the electric machine does not have a rotor position sensor for detecting the rotor position of the rotor.

8. The electric machine according to claim 6, wherein
the electric machine is configured for use in an electrically operable or hybrid drive train of a motor vehicle.

9. An inspection and/or test method for checking an electric machine, according to claim 6 in a test stand, wherein, for operating the electric machine in the test stand, the initial rotor position of the rotor of the electric machine is determined.

10. An inspection and/or test method for checking an electric machine, in a test stand, wherein the test stand for operating the electric machine comprises a control unit according to claim 4 for controlling and energizing the electric machine and the initial rotor position of the rotor of the electric machine is determined.

11. A test stand for carrying out an inspection and/or test method for checking an electric machine, comprising a holder for the electric machine and a control unit according to claim 4 for controlling and energizing the electric machine.
